(19) United States
(12) Patent Application Publication
(10) Pub. No.: US 2019/0135075 A1
(43) Pub. Date: May 9, 2019

(54) HEAT PUMP SYSTEM FOR VEHICLE

(71) Applicant: HANON SYSTEMS, Daejeon (KR)

(72) Inventors: In Guk HWANG, Daejeon (KR); Hae Jun LEE, Daejeon (KR)

(21) Appl. No.: 16/072,207

(22) PCT Filed: Jul. 10, 2017
(86) PCT No.: PCT/KR2017/007344

§ 371 Date: Jul. 24, 2018

(30) Foreign Application Priority Data
Jul. 11, 2016 (KR) 10-2016-0087338

(51) Int. Cl. B60H 1/00; F25B 5/02; F25B 6/04; F25B 41/00; F25B 41/04; F25B 41/06; B60H 1/32; B60H 3/02

(52) U.S. Cl. CPC B60H 1/00921; F25B 2500/18; F25B 5/02; F25B 6/04; F25B 41/003; F25B 41/04; F25B 41/062; B60H 1/0045; B60H 1/323; B60H 3/024; B60H 2001/00928; B60H 2001/00949; F25B 2339/047; F25B 2400/0403; B60H 1/00278

(57) ABSTRACT

The present invention relates to a heat pump system for a vehicle and, more particularly, to a heat pump system for a vehicle comprising: a first cooling water line connecting an outdoor heat exchanger (electric radiator) and an electronic component; a second cooling water line connecting a chiller and a battery; and a cooling water control means for controlling a flow of cooling water by connecting the first cooling water line and the second cooling water line. As such, not only waste heat of the electronic component but also waste heat of the battery can be utilized by means of the chiller in a heating mode to thereby improve heating performance, and the battery is cooled in a cooling mode so that heat exchange of the battery is possible.

### TECHNICAL FIELD

The present invention relates to a heat pump system for a vehicle and, more particularly, to a heat pump system for a vehicle, which includes: a first cooling water line connecting an outdoor heat exchanger (electric radiator) and an electronic component with each other; a second cooling water line connecting a chiller and a battery with each other; and a cooling water control means connecting the first cooling water line and the second cooling water line with each other to control a flow of cooling water, thereby utilizing not only waste heat of the electronic component but also waste heat of the battery by means of the chiller in a heating mode and cooling the battery in a cooling mode to make heat exchange of the battery possible.

### BACKGROUND ART

An air conditioner for a vehicle includes a cooling system for cooling the interior of the vehicle, and a heating system for heating the interior of the vehicle. The cooling system converts the air, which passes the outside of an evaporator, into cold air by exchanging heat between the air and refrigerant, which flows inside the evaporator, from the evaporator side to cool the interior of the vehicle. The heating system converts the air, which passes the outside of a heater core of a cooling water cycle, into warm air by exchanging heat between the air and cooling water, which flows inside the heater core, from the heater core side to heat the interior of the vehicle.

In the meantime, differently from the air conditioner for the vehicle, a heat pump system which is capable of selectively carrying out cooling and heating by changing a flow direction of refrigerant using one refrigerant cycle is disclosed. The heat pump system includes, for instance, two heat exchangers, namely, an indoor heat exchanger mounted inside an air-conditioning case to exchange heat with air blown to the interior of the vehicle and an outdoor heat exchanger mounted outside the air-conditioning case to exchange heat, and a direction-changing valve for changing a flow direction of refrigerant. Therefore, the indoor heat exchanger serves as a heat exchanger for cooling when the heat pump system runs in a cooling mode according to the flow direction of refrigerant by the direction-changing valve and also serves as a heat exchanger for heating when the heat pump system runs in a heating mode.

There are various kinds of heat pump systems for vehicles, and FIG. 1 illustrates one of representative heat pump systems.

The heat pump system for a vehicle illustrated in FIG. 1 includes: a compressor 30 for compressing and discharging refrigerant; an indoor heat exchanger 32 for radiating heat of the refrigerant discharged from the compressor 30; a first expansion valve 34 and a first bypass valve 36, which are mounted in a parallel structure to selectively pass the refrigerant, which passed the indoor heat exchanger 32; an outdoor heat exchanger 48 for exchanging heat between outdoor air and the refrigerant passing the first expansion valve 34 or the first bypass valve 36; an evaporator 60 for evaporating the refrigerant passing the outdoor heat exchanger 48; an accumulator 62 for dividing the refrigerant passing the evaporator 60 into gas-phase refrigerant and liquid-phase refrigerant; an internal heat exchanger 50 for exchanging heat between refrigerant supplied to the evaporator 60 and refrigerant returning to the compressor 30; a second expansion valve 56 for selectively expanding the refrigerant supplied to the evaporator 60; and a second bypass valve 58 mounted in parallel with the second expansion valve 62 to selectively connect an outlet side of the outdoor heat exchanger 48 and an inlet side of the accumulator 62.

In FIG. 1, the reference numeral 10 designates an air-conditioning case in which the indoor heat exchanger 32 and the evaporator 60 are built, the reference numeral 12 designates a temperature-adjusting door for adjusting a mixed amount of cold air and warm air, and the reference numeral 20 designates a blower mounted at an inlet of the air-conditioning case.

According to the heat pump system for the vehicle having the above-mentioned structure, in a heating mode (heat pump mode), the first bypass valve 36 and the second expansion valve 56 are closed, and the first expansion valve 34 and the second bypass valve 58 are opened. Moreover, the temperature-adjusting door 12 is operated as shown in FIG. 1. Therefore, the refrigerant discharged from the compressor 30 passes through the indoor heat exchanger 32, the first expansion valve 34, the outdoor heat exchanger 48, a high pressure part 52 of the internal heat exchanger 50, the second bypass valve 58, the accumulator 62 and a low pressure part 54 of the internal heat exchanger 50 in order, and returns to the compressor 30. That is, the indoor heat exchanger 32 serves as a heater and the outdoor heat exchanger 48 serves as an evaporator.

In a cooling mode, the first bypass valve 36 and the second expansion valve 56 are opened, and the first expansion valve 34 and the second bypass valve 58 are closed. Furthermore, the temperature-adjusting door 12 closes a passage of the indoor heat exchanger 32. Therefore, the refrigerant discharged from the compressor 30 passes through the indoor heat exchanger 32, the first bypass valve 36, the outdoor heat exchanger 48, the high pressure part 52 of the internal heat exchanger 50, the second expansion valve 56, the evaporator 60, the accumulator 62, and the low pressure part of the internal heat exchanger 50 in order, and then, returns to the compressor 30. In this instance, the indoor heat exchanger 32 closed by the temperature-adjusting door 12 serves as a heater in the same way as the heating mode.

However, in the heating mode of the heat pump system for the vehicle, the indoor heat exchanger 32 mounted inside the air-conditioning case 10 serves as the heater, namely, radiates heat to perform heating, and the outdoor heat exchanger 48 is mounted outside the air-conditioning case 10, namely, at the front part of an engine room of the vehicle, to serve as an evaporator for exchanging heat with outdoor air, namely, to absorb heat. In this instance, if outdoor temperature is below zero or if frosting is made on the outdoor heat exchanger 48, it is almost impossible that the outdoor heat exchanger 48 absorbs heat, and temperature of air discharged to the interior of the vehicle drops and heating performance is deteriorated because temperature and pressure of the refrigerant inside the system get lower.

In order to solve the above problems, Korean Patent No. 1342931 which has been filed by the same applicant as the present invention and entitled a ‘heat pump system for vehicle’ carries out a defrosting mode so that refrigerant bypasses the outdoor heat exchanger and recovers waste heat of an electric component of the vehicle through a heat supplying means (chiller) when frosting is made on the outdoor heat exchanger, so as to continue heating not only when frosting is made on the outdoor heat exchanger but also when outdoor temperature is below zero.

However, the conventional heat pump system has several disadvantages in that heating performance is deteriorated because a waste heat recovery amount is not sufficient when refrigerant bypasses the outdoor heat exchanger and waste heat of a vehicle electric component is used according to frosting of the outdoor heat exchanger or conditions of outdoor temperature, and in that a PTC heater must be additionally operated in order to maintain indoor temperature.

Additionally, the conventional heat pump system has further disadvantages in that it carries out only heating and cooling modes, and in that it has no heat exchanging function of a vehicle battery, namely, additional devices for cooling the battery must be used.

### DISCLOSURE

### Technical Problem

Accordingly, the present invention has been made in view of the above-mentioned problems occurring in the prior art, and it is an object of the present invention to provide a heat pump system for a vehicle, which includes: a first cooling water line connecting an outdoor heat exchanger (electric radiator) and an electronic component with each other; a second cooling water line connecting a chiller and a battery with each other; and a cooling water control means connecting the first cooling water line and the second cooling water line with each other to control a flow of cooling water, thereby utilizing not only waste heat of the electronic component but also waste heat of the battery by means of the chiller in a heating mode and cooling the battery in a cooling mode to make heat exchange of the battery possible.

### Technical Solution

To accomplish the above object, according to the present invention, there is provided a heat pump system for a vehicle in which a compressor, an outdoor heat exchanger, an expansion means, and an evaporator are connected to a refrigerant circulation line, including: a chiller connected to the refrigerant circulation line through a first bypass line in parallel; a first cooling water line which connects the outdoor heat exchanger and an electric component for the vehicle to circulate cooling water; a second cooling water line which connects the chiller and a battery for the vehicle to circulate cooling water; and a cooling water adjusting means which connects the first cooling water line and the second cooling water line with each other to adjust a flow of cooling water between the first and second cooling water lines, wherein through the chiller, waste heat of the electric component or the battery is recovered in a heating mode, and the battery is cooled to make heat management of the battery possible in a cooling mode.

### Advantageous Effects

As described above, the heat pump system for a vehicle according to an embodiment of the present invention includes: a first cooling water line connecting an outdoor heat exchanger (electric radiator) and an electronic component with each other; a second cooling water line connecting a chiller and a battery with each other; and a cooling water control means connecting the first cooling water line and the second cooling water line with each other to control a flow of cooling water, thereby utilizing not only waste heat of the electronic component but also waste heat of the battery by means of the chiller in a heating mode and cooling the battery in a cooling mode to make heat exchange of the battery possible.

Moreover, the heat pump system for a vehicle according to an embodiment of the present invention can utilize the electric radiator for cooling the existing electric component without installation of additional radiator for cooling the battery so as to reduce manufacturing costs because the electric radiator can cool not only the electric component but also the battery.

Furthermore, the heat pump system for a vehicle according to an embodiment of the present invention can maintain the optimum temperature of the battery to enhance efficiency of the battery because it can cool and heat the battery using the electric radiator, the chiller and the heating means.

### DESCRIPTION OF DRAWINGS

FIG. 1 is a configurative diagram of a conventional heat pump system for a vehicle.

FIG. 2 is a configurative diagram of a heat pump system for a vehicle according to a preferred embodiment of the present invention.

FIG. 3 is a configurative diagram showing a state where a battery is cooled using a chiller in a cooling mode of the heat pump system for the vehicle according to the preferred embodiment of the present invention.

FIG. 4 is a configurative diagram showing a state where a battery is cooled using an electric radiator in the cooling mode of the heat pump system for the vehicle according to the preferred embodiment of the present invention.

FIG. 5 is a configurative diagram showing a state where waste heat of an electric component and the battery is recovered in a heating mode of the heat pump system for the vehicle according to the preferred embodiment of the present invention.

FIG. 6 is a configurative diagram showing a state where waste heat of the electric component is recovered in a heating mode of the heat pump system for the vehicle according to the preferred embodiment of the present invention.

FIG. 7 is a configurative diagram showing a state where waste heat of the battery is recovered in a heating mode of the heat pump system for the vehicle according to the preferred embodiment of the present invention.

FIG. 8 is a perspective view of a chiller and an expansion valve of the heat pump system for a vehicle according to the preferred embodiment of the present invention.

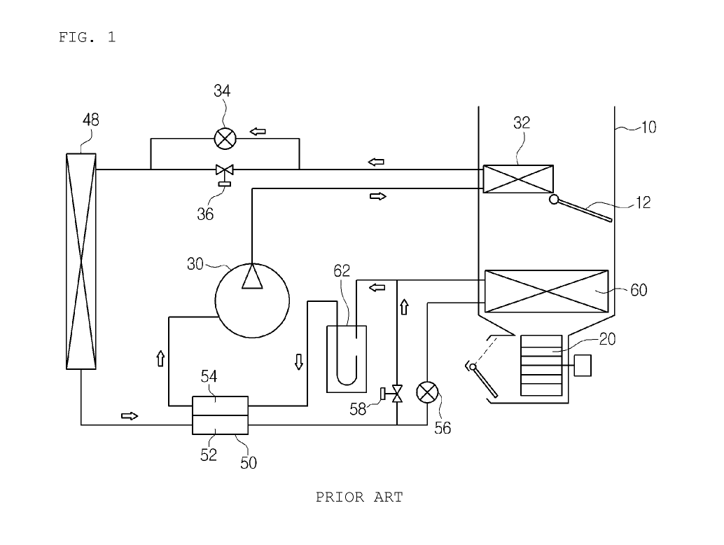

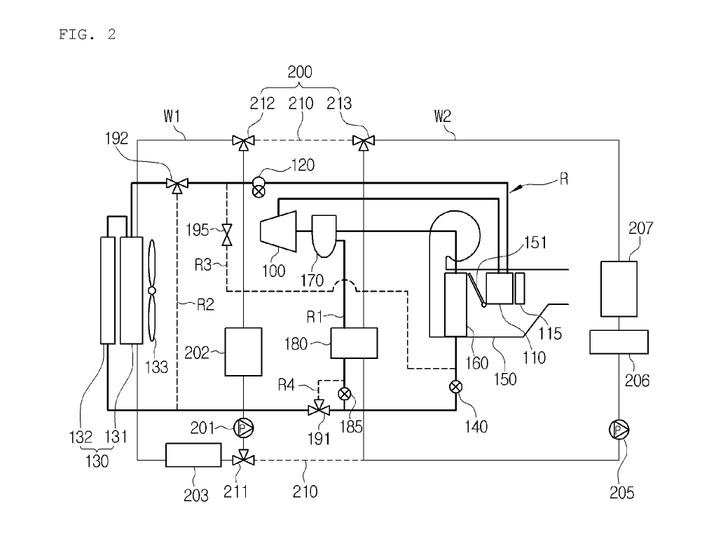

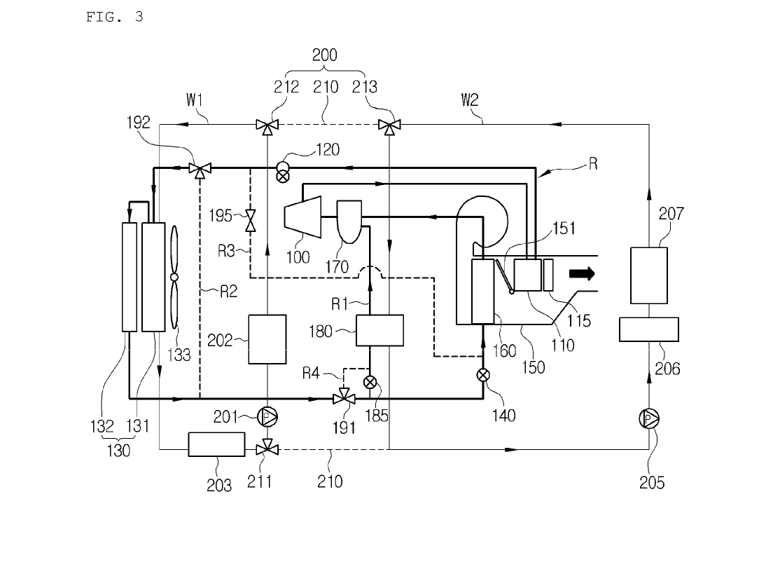

### MODE FOR INVENTION

Reference will be now made in detail to a preferred embodiment of the present invention with reference to the attached drawings.

A heat pump system for a vehicle according to a preferred embodiment of the present invention is, preferably, applied to electric vehicles or hybrid vehicles, and in the heat pump system, a compressor 100, an indoor heat exchanger 110, an outdoor heat exchanger 130, an expansion means, and an evaporator 160 are connected to a refrigerant circulation line R.

The expansion means includes a first expansion means 120 mounted on the refrigerant circulation line R between the indoor heat exchanger 110 and the outdoor heat exchanger 130, and a second expansion means 140 mounted on the refrigerant circulation line R between the outdoor heat exchanger 130 and the evaporator 160.

Moreover, on the refrigerant circulation line R, a first bypass line R1 bypassing the second expansion means 140 and the evaporator 160 and a second bypass line R2 bypassing the outdoor heat exchanger 130 are connected and mounted in parallel, and a chiller 180 is mounted on the first bypass line R1.

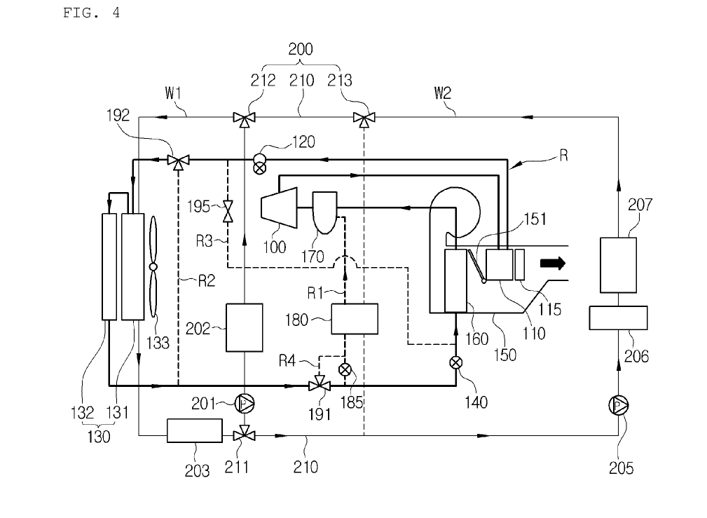

Therefore, in a cooling mode, as shown in FIG. 3, a flow of refrigerant is controlled such that the refrigerant discharged from the compressor 100 circulates the indoor heat exchanger 110, the first expansion means 120 (non-expansion), the outdoor heat exchanger 130, the second expansion means 140 (expansion), the evaporator 160, and the compressor 100 in order. In this instance, the indoor heat exchanger 110 and the outdoor heat exchanger 130 serve as a condenser, and the evaporator 160 serves as an evaporator.

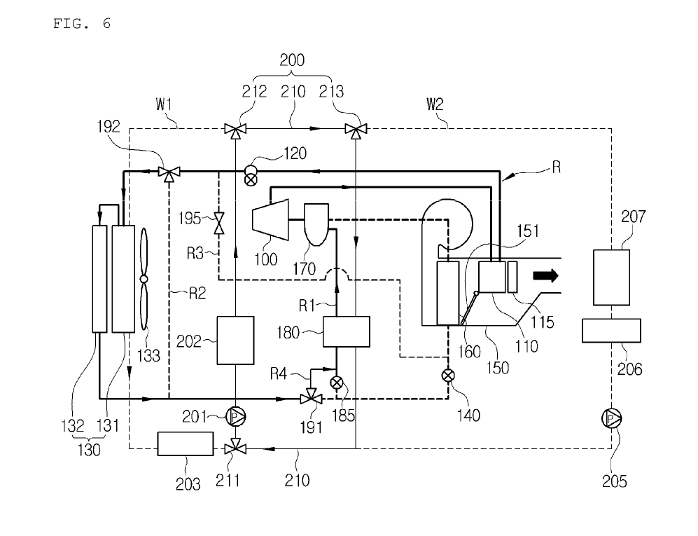

In a heating mode (heat pump mode), as shown in FIG. 5, a flow of refrigerant is controlled such that the refrigerant discharged from the compressor 100 circulates the indoor heat exchanger 110, the first expansion means 120 (expansion), the outdoor heat exchanger 130, the chiller 180 of the first bypass line R1, and the compressor 100. In this instance, the indoor heat exchanger 110 serves as a condenser, the outdoor heat exchanger 130 serves as an evaporator, and the refrigerant is not supplied to the second expansion means 140 and the evaporator 160.

In the meantime, in the heating mode, when the interior of the vehicle is dehumidified, some of the refrigerant circulating the refrigerant circulation line R is supplied to the evaporator 160 through a dehumidification line R3, which will be described later, in order to dehumidify the interior of the vehicle.

Hereinafter, components of the heat pump system will be described in detail.

First, the compressor 100 mounted on the refrigerant circulation line R absorbs and compresses refrigerant while receiving driving power from an engine (internal combustion engine) or a motor to run, and then, discharges the refrigerant in a gas phase of high-temperature and high-pressure.

The compressor 100 absorbs and compresses the refrigerant discharged from the evaporator 160 and supplies to the indoor heat exchanger 110 in the cooling mode, and absorbs and compresses the refrigerant discharged from the outdoor heat exchanger 130 and passing the first bypass line R1 and supplies to the indoor heat exchanger 110 in the heating mode.

Moreover, in the dehumidification mode of the heating ode, because refrigerants are simultaneously supplied to the evaporator 160 through the first bypass line R1 and the dehumidification line R3, which will be described later. In this instance, the compressor 100 absorbs and compresses the refrigerants meeting together after passing the first bypass line R1 and the evaporator 160, and then, supplies to the indoor heat exchanger 110.

The indoor heat exchanger 110 is mounted inside an air-conditioning case 150 and is connected with the refrigerant circulation line R of an outlet side of the compressor 100 in order to exchange heat between air flowing inside the air-conditioning case 150 and the refrigerant discharged from the compressor 100.

Furthermore, the evaporator 160 is mounted inside the air-conditioning case 150 and is connected with the refrigerant circulation line R of an inlet side of the compressor 100 in order to exchange heat between air flowing inside the air-conditioning case 150 and the refrigerant flowing to the compressor 100.

The indoor heat exchanger 110 serves as a condenser not only in the cooling mode but also in the heating mode.

The evaporator 160 serves as an evaporator in the cooling mode, is stopped in the heating mode because refrigerant is not supplied, and serves as an evaporator in the dehumidification mode because some of the refrigerant is supplied.

Additionally, the indoor heat exchanger 110 and the evaporator 160 are mounted inside the air-conditioning case 150 to be spaced apart from each other at a predetermined interval, and in this instance, the evaporator 160 and the indoor heat exchanger 110 are mounted in order from the upstream side of an air flow direction inside the air-conditioning case 150.

Therefore, in the cooling mode that the evaporator 160 serves as an evaporator, as shown in FIG. 3, refrigerant of low-temperature and low-pressure discharged from the second expansion means 140 is supplied to the evaporator 160, and in this instance, the air flowing inside the air-conditioning case 150 through a blower (not shown) exchanges heat with the refrigerant of low-temperature and low-pressure of the inside of the evaporator 160 to be converted into cold air, and then, is discharged to the interior of the vehicle to cool the interior of the vehicle.

In the heating mode that the indoor heat exchanger 110 serves as a condenser, as shown in FIG. 5, refrigerant of high-temperature and high-pressure discharged from the compressor 100 is supplied to the indoor heat exchanger 110, and in this instance, the air flowing inside the air-conditioning case 150 through the blower (not shown) exchanges heat with the refrigerant of high-temperature and high-pressure of the inside of the indoor heat exchanger 110 to be converted into warm air, and then, is discharged to the interior of the vehicle to heat the interior of the vehicle.

Additionally, a temperature-adjusting door 151 for adjusting an amount of air bypassing the indoor heat exchanger 110 and an amount of air passing the indoor heat exchanger 110 is mounted between the evaporator 160 and the indoor heat exchanger 110 inside the air-conditioning case 150.

The temperature-adjusting door 151 adjusts the amount of air bypassing the indoor heat exchanger 110 and the amount of air passing the indoor heat exchanger 110 to properly control temperature of the air discharged from the air-conditioning case 150.

In this instance, in the cooling mode, as shown in FIG. 3, when the temperature-adjusting door 151 completely closes a front side passage of the indoor heat exchanger 110, cold air passing the evaporator 160 bypasses the indoor heat exchanger 110 and is supplied to the interior of the vehicle so as to carry out cooling to the maximum. In the heating mode, as shown in FIG. 5, when the temperature-adjusting door 151 completely closes a passage bypassing the indoor heat exchanger 110, all of airs are changed into warm air while passing the indoor heat exchanger 110, which serves as a condenser, and the warm air is supplied into the interior of the vehicle to carry out heating to the maximum.

In addition, the outdoor heat exchanger 130 is mounted outside the air-conditioning case 150 and is connected with the refrigerant circulation line R, and includes an electric radiator 131 for exchanging heat between the refrigerant of the refrigerant circulation line R and cooling water of a first cooling water line W1, which will be described later, and an air-cooled heat exchanger 132 for exchanging heat between air and refrigerant of the refrigerant circulation line R.

Here, the electric radiator 131 and the air-cooled heat exchanger 132 of the outdoor heat exchanger 130 are mounted at the front side of an engine room of the vehicle, and are arranged in a straight line in a flow direction of air blown from a blast fan 133.

Therefore, the refrigerant, the cooling water and the air exchange heat with one another by the electric radiator 131, and the refrigerant and the air exchange heat with each other by the air-cooled heat exchanger 132.

The outdoor heat exchanger 130 serves as a condenser like the indoor heat exchanger 110 in the cooling mode, and serves as an evaporator differently from the indoor heat exchanger 110 in the heating mode.

Moreover, the first expansion means 120 is mounted on the refrigerant circulation line R between the indoor heat exchanger 110 and the outdoor heat exchanger 130, and selectively expands the refrigerant supplied to the outdoor heat exchanger 130 depending on the cooling mode or the heating mode.

The first expansion means 120 is an orifice-integrated on-off valve, namely, lets the refrigerant flow in a non-expanded state when the on-off valve is opened but lets the refrigerant flow in an expanded state through an orifice disposed on the on-off valve.

Because the orifice-integrated on-off valve has been known, detailed description of the orifice-integrated on-off valve will be omitted.

Furthermore, the first bypass line R1 branches off from the refrigerant circulation line R of the outlet side of the outdoor heat exchanger 130 and is connected to meet with the refrigerant circulation line R of an outlet side of the evaporator 160, so that the refrigerant passing the outdoor heat exchanger 130 bypasses the evaporator 160.

Of course, the refrigerant passing the outdoor heat exchanger 130 bypasses the second expansion means 140 and the evaporator 160 when flowing to the first bypass line R1.

As shown in the drawings, the first bypass line R1 is mounted in parallel with the second expansion means 140 and the evaporator 160, that is, an inlet side of the first bypass line R1 is connected with the refrigerant circulation line R connecting the outdoor heat exchanger 130 and the second expansion means 140 and an outlet side of the first bypass line R1 is connected with the refrigerant circulation line R connecting the evaporator 160 and the compressor 100.

Accordingly, in the cooling mode, the refrigerant passing the outdoor heat exchanger 130 flows toward the second expansion means 140 and the evaporator 160, but in the heating mode, directly flows toward the compressor 100 through the first bypass line R1 and bypasses the second expansion means 140 and the evaporator 160.

Here, the change in the flow direction of the refrigerant depending on the cooling mode and the heating mode is achieved by a first refrigerant direction-changing valve 191.

Of course, a control unit (not shown) controls components including the first refrigerant direction-changing valve 191, a second refrigerant direction-changing valve 192, which will be described later, the on-off valve 195, and the first and second expansion means 120 and 140 in order to control a flow of the refrigerant circulating in the heat pump system depending on the cooling mode and the heating mode.

Additionally, the second bypass line R2 is mounted on the refrigerant circulation line R in parallel so that the refrigerant passing the first expansion means 120 bypasses the outdoor heat exchanger 130. That is, the second bypass line R2 connects the refrigerant circulation line R of an inlet side of the outdoor heat exchanger 130 with the refrigerant circulation line R of the outlet side to be mounted in parallel with the outdoor heat exchanger 130, so that the refrigerant circulating in the refrigerant circulation line R bypasses the outdoor heat exchanger 130.

Moreover, the second refrigerant direction-changing valve 192 for changing the flow direction of the refrigerant is mounted such that the refrigerant circulating in the refrigerant circulation line R selectively flows to the second bypass line R2. The second refrigerant direction-changing valve 192 is mounted at a branching point between the second bypass line R2 and the refrigerant circulation line R to change the flow direction of the refrigerant, so that the refrigerant flows to the outdoor heat exchanger 130 or the second bypass line R2.

Furthermore, the dehumidification line R3 for supplying some of the refrigerant circulating in the refrigerant circulation line R toward the evaporator 160 is mounted on the refrigerant circulation line R in order to dehumidify the interior of the vehicle.

The dehumidification line R3 is mounted to supply some of the refrigerant of low-temperature and low-pressure passing the first expansion means 120 to the evaporator 160.

That is, the dehumidification line R3 is mounted to connect the refrigerant circulation line R of an outlet side of the first expansion means 120 with the refrigerant circulation line R of an inlet side of the evaporator 160.

As shown in the drawings, an inlet of the dehumidification line R3 is connected to the refrigerant circulation line R between the first expansion means 120 and the outdoor heat exchanger 130, so that some of the refrigerant before flowing into the outdoor heat exchanger 130 after passing the first expansion means 120 flows to the dehumidification line R3 to be supplied to the evaporator 160.

In other words, in the dehumidification mode of the heating mode, the refrigerant passing the compressor 100, the indoor heat exchanger 110 and the first expansion means 120 is divided into two, so that some of the refrigerant circulates toward the outdoor heat exchanger 130 and the rest circulates toward the evaporator 160 through the dehumidification line R3, and the divided refrigerants meet together at the inlet side of the compressor 100.

Additionally, the on-off valve 195 which opens and closes the dehumidification line R3 is mounted on the dehumidification line R3 so that some of the refrigerant passing the first expansion means 120 can flow to the dehumidification line R3 only in the dehumidification mode.

The on-off valve 195 opens the dehumidification line R3 only in the dehumidification mode and closes the dehumidification line R3 not in the dehumidification mode.

An outlet of the dehumidification line R3 is connected with the refrigerant circulation line R of the inlet side of the evaporator 160 so that the refrigerant passing through the dehumidification line R3 directly flows into the evaporator 160.

In addition, the chiller 180 is connected to the refrigerant circulation line R in parallel through the first bypass line R1.

The chiller 180 is mounted on the first bypass line R1 so as to exchange heat between the refrigerant flowing through the first bypass line R1 and the cooling water circulating through a battery 207.

The chiller 180 includes a cooling water heat exchanging part connected with a second cooling water line W2, which will be described later, and a refrigerant heat exchanging part connected with the first bypass line R1.

Therefore, in the cooling mode, the refrigerant does not flow to the first bypass line R1, but flows to the first bypass line R1 when the battery 207 is cooled in the cooling mode. In this instance, the chiller 180 exchanges heat between the refrigerant of the first bypass line R1 and the cooling water of the second cooling water line W2 to cool the cooling water, so it is possible to manage heat of the battery 207.

In the heating mode, refrigerant flows to the first bypass line R1, and in this instance, the chiller 180 exchanges heat between the refrigerant of the first bypass line R1 and the cooling water circulating through the battery 207 to use not only waste heat of an electric component 202 but also waste heat of the battery 207 so as to enhance heating performance.

As described above, because waste heat of the electric component 202 and waste heat of the battery 207 may be used through the chiller 180 even in the mode that the refrigerant bypasses the outdoor heat exchanger 130 depending on frosting of the outdoor heat exchanger 130 or conditions of outdoor temperature, it can minimize a change in indoor discharge temperature due to lack of a heat source, so the frequency of use of an electric heater 115 is reduced, power consumption is reduced, and the mileage of electric vehicles or hybrid vehicles increases.

Moreover, the first cooling water line W1 for circulating cooling water through connection of the outdoor heat exchanger 130 and the electric component 202 of the vehicle, and the second cooling water line W2 for circulating cooling water through connection of the chiller 180 and the vehicle battery 207 are mounted.

Furthermore, a first water pump 201 for circulating cooling water and a reservoir tank 203 for storing the cooling water are mounted on the first cooling water line W1, and a second water pump 205 for circulating the cooling water is mounted on the second cooling water line W2.

That is, the first water pump 201, the electric component 202, the electric radiator 131 of the outdoor heat exchanger 130, and the reservoir tank 203 are connected on the first cooling water line W1 in order in the flow direction of the cooling water, and the second water pump 205, the battery 207 and the chiller 180 are connected on the second cooling water line W 2 in order in the flow direction of the cooling water.

Additionally, a heating means 206 for heating the cooling water circulating to the battery 207 is mounted on the second cooling water line W2.

That is, when temperature-rising of the battery 207 is required under a condition that outdoor temperature is low, namely, in a case that outdoor temperature is below zero, the heating means 206 heats the cooling water circulating to the battery 207 so as to enhance efficiency of the battery 207 by optimizing temperature of the battery 207.

Preferably, the heating means 206 is an electric heater, and the electric component 202 is a motor, an inverter, or others.

In the meantime, the heating means 206 is preferably mounted on the second cooling water line W2 of the inlet side of the battery 207.

In addition, a cooling water adjusting means 200 for adjusting a flow of the cooling water is mounted between the first and second cooling water lines W1 and W2, and connects the first cooling water line W1 and the second cooling water line W2 with each other, so that waste heat of the electric component 202 or the battery 207 is recovered through the chiller 180 in the heating mode and the battery is cooled in the cooling mode. So, it is possible to manage heat of the battery 207 due to the cooling water adjusting means 200.

The cooling water adjusting means 200 includes a connection line 210, which connects the first cooling water line W1 and the second cooling water line W2 in parallel so as to arrange the outdoor heat exchanger 130, the electric component 202, the chiller 180 and the battery 207 in parallel, and a valve which is mounted at a branching point of the first and second cooling water lines W1 and W2 and the connection line 210 to adjust a flow of the cooling water.

In more detail, the connection line 210 includes a line for connecting the first cooling water line W1 between the reservoir tank 203 and the first water pump 201 with the second cooling water line W2 between the chiller 180 and the second water pump 205; and a line for connecting the first cooling water line W1 between the electric component 202 and the electric radiator 131 and the second cooling water line W2 between the battery 207 and the chiller 180, and the first cooling water line W1 and the second cooling water line W2 are connected in parallel.

The valve includes: first and second cooling water direction-changing valves 211 and 212 respectively mounted at branching points of the first cooling water line W1 and the connection line 210 of inlet and outlet sides of the electric component 202; and a third cooling water direction-changing valve 213 mounted at a branching point between the second cooling water line W2 and the connection line 210 of an inlet side of the chiller 180.

The first, second and third cooling water direction-changing valves 211, 212 and 213 are three way valves, and the first and second refrigerant direction-changing valves 191 and 192 are also three way valves.

Therefore, as shown in FIGS. 3 to 7, the flow of the cooling water between the first cooling water line W1 and the second cooling water line W2 can be adjusted in various ways through a control of the valves.

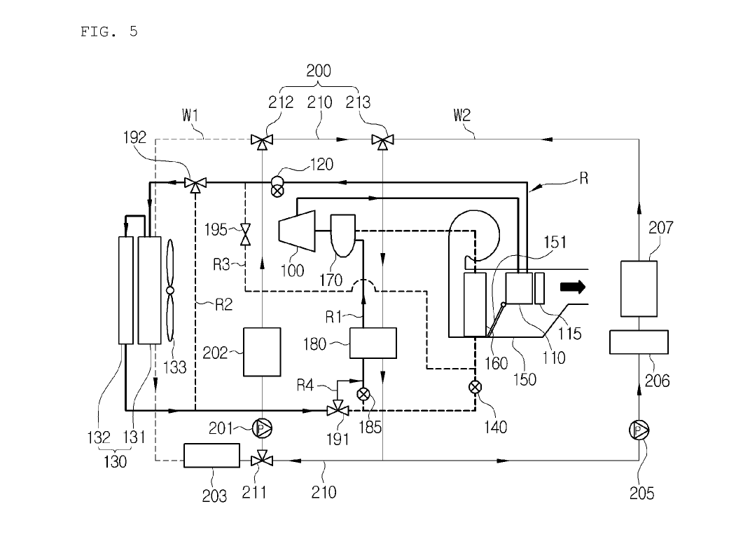

FIGS. 3 and 4 illustrate states where the battery is cooled in the cooling mode. First, in FIG. 3, the cooling water adjusting means 200 is controlled such that the cooling water cooled in the electric radiator 131 of the outdoor heat exchanger 130 circulates toward the electric component 202 of the first cooling water line W1 and the cooling water cooled in the chiller 180 circulates toward the battery 207 of the second cooling water line W2.

That is, because the first cooling water line W1 and the second cooling water line W2 independently circulate the cooling water, the electric component 202 is cooled through the cooling water, which is cooled in the electric radiator 131 and circulates, and the battery 207 is cooled through the cooling water, which is cooled in the chiller 180 and circulates.

In this instance, the refrigerant is controlled to circulate toward the chiller 180.

As shown in FIG. 3, under the condition that outdoor temperature is high, because temperature of the cooling water cooled in the electric radiator 131 does not satisfy a temperature condition required for cooling the battery 207, the first cooling water line W1 and the second cooling water line W2 are operated independently to cool the battery 207 using the chiller 180.

In FIG. 4, the cooling water adjusting means 200 is controlled such that the cooling water cooled in the outdoor heat exchanger 130 circulates through the electric component 202 of the first cooling water line W1 and the battery 207 of the second cooling water line W2.

That is, when temperature of the cooling water cooled in the electric radiator 131 satisfies the temperature condition required for cooling the battery 207 because outdoor temperature is not high, the cooling water cooled in the electric radiator 131 circulates to the electric component 202 and the battery 207 to cool the electric component 202 and the battery 207.

In this instance, the cooling water does not circulate toward the chiller 180.

FIGS. 5 to 7 illustrate states where waste heat is recovered in the heating mode. First, in FIG. 5, the cooling water adjusting means 200 is controlled such that the cooling water heated in the electric component 202 and the cooling water heated in the battery 207 circulate toward the chiller 180 of the second cooling water line W2.

FIG. 5 illustrates a state where waste heat of the electric component 202 and waste heat of the battery 207 are all used because all of the electric component 202 and the battery 207 generate heat sufficiently.

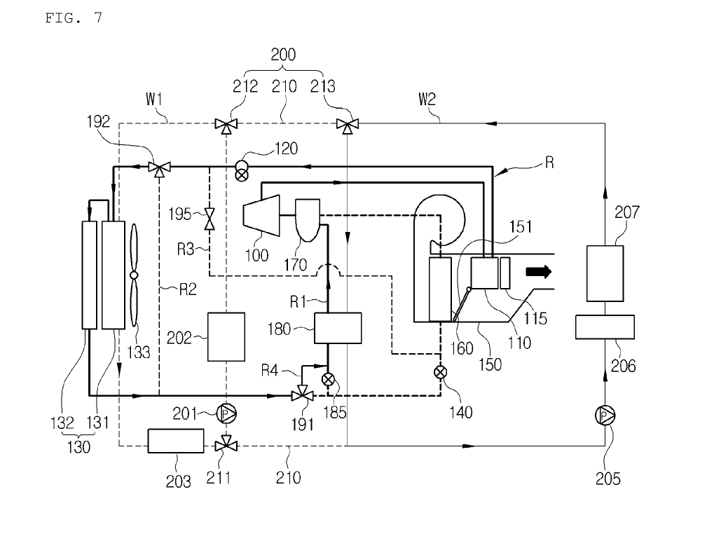

In FIG. 6, the cooling water adjusting means 200 is controlled such that only the cooling water heated in the electric component 202 circulates toward the chiller of the second cooling water line W2.

FIG. 6 illustrates a state where only waste heat of the electric component 202 is used because the electric component 202 generates heat but the battery 207 does not generate heat sufficiently.

In FIG. 7, the cooling water adjusting means 200 is controlled such that only the cooling water heated in the battery 207 circulates toward the chiller 180 of the second cooling water line W2.

FIG. 7 illustrates a state where only waste heat of the battery 207 is used because the battery 207 generates heat but the electric component 202 does not generate heat sufficiently.

In the meantime, under the condition that temperature-rising of the battery 207 is required, the heating means 206 is operated to raise temperature of the battery 207 and supply heat to the heat pump system.

Moreover, an expansion channel 186 for expanding refrigerant and an expansion valve 185 having a bypass channel 187 bypassing the expansion channel 186 are mounted on the first bypass line R1 of the inlet side of the chiller 180 in order to selectively expand the refrigerant flowing to the chiller 180.

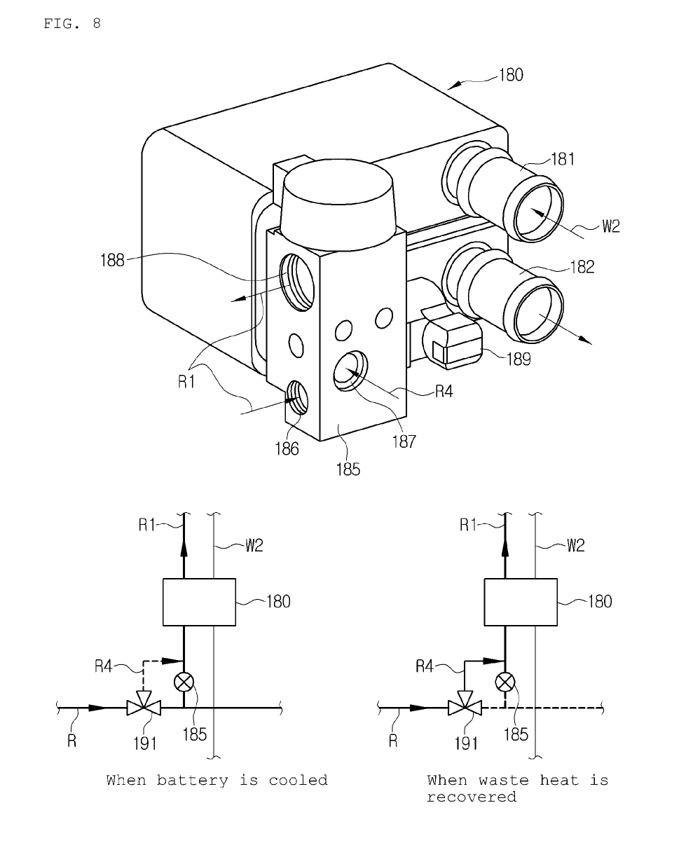

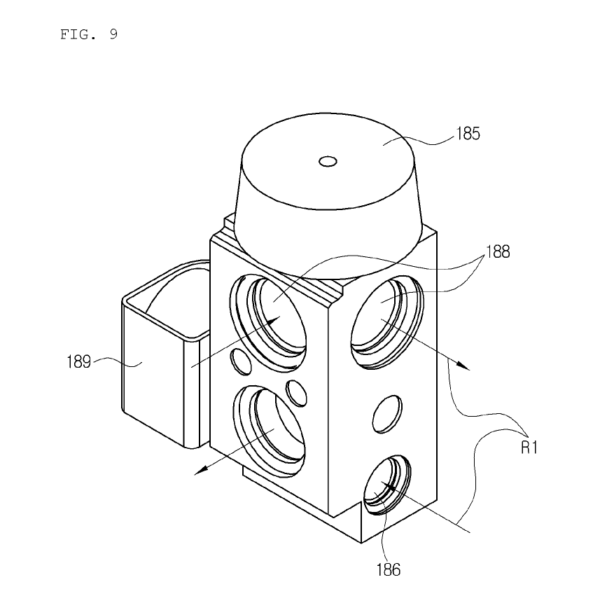

As shown in FIG. 8, the expansion valve 185 is combined to one side of the chiller 180, and includes a solenoid valve 189 for opening and closing the expansion channel 186.

As shown in FIG. 8, an inlet of the expansion channel 186 and an inlet of the bypass channel 187 is divided at the expansion valve 185, but an outlet of the expansion channel 186 and an outlet of the bypass channel 187 are joined into one (see FIG. 9).

Furthermore, the solenoid valve 189 selectively opens and closes the expansion channel 186, namely, the degree of opening of the expansion channel 186 is adjusted according to conditions, and in this instance, the expansion channel 186 can be opened and closed through the solenoid valve 189 even under a condition that the expansion channel 186 is opened.

Meanwhile, refrigerant flowing in the bypass channel 187 flows to the chiller 180 in a non-expanded state because bypassing the expansion channel 186.

Additionally, a refrigerant passage 188 through which refrigerant discharged from the chiller 180 passes is formed at the expansion valve 185.

The expansion valve 185 is connected with a refrigerant inlet (not shown) of the chiller 180 because an outlet of the expansion channel 186 and an outlet of the bypass channel 187 are formed into one, and the refrigerant passage 188 is connected with a refrigerant outlet (not shown) of the chiller 180.

In addition, the chiller 180 includes a cooling water inlet 181 and a cooling water outlet 182 to which the second cooling water line W2 is connected.

Moreover, an auxiliary bypass line R4 is formed to connect the refrigerant circulation line R before the first bypass line R1 branches off and the bypass channel 187 of the expansion valve 185 with each other.

A first refrigerant direction-changing valve 191 is mounted at a branching point between the refrigerant circulation line R and the auxiliary bypass line R4.

The first refrigerant direction-changing valve 191 closes the auxiliary bypass line R4 in the cooling mode so that the refrigerant discharged from the outdoor heat exchanger 130 flows toward the second expansion means 140 and the evaporator 160, and opens the auxiliary bypass line R4 in the heating mode so that the refrigerant discharged from the outdoor heat exchanger 130 flows toward the chiller 180.

Of course, in the cooling mode, if cooling of the battery 207 is required, the solenoid valve 189 opens the expansion channel 186 of the expansion valve 185 so that some of the refrigerant discharged from the outdoor heat exchanger 130 is expanded and flows to the chiller 180.

As described above, because the expansion valve 185, which can open and close the expansion channel 186 by the solenoid valve 189 and has the bypass channel 187, is mounted at the inlet side of the chiller 180, some of refrigerant can be supplied to the chiller 180 in the cooling mode to cool the battery 207 and the refrigerant bypassing the expansion channel 186 through the bypass channel 187 can be supplied to the chiller 180 in the heating mode to recover waste heat.

Furthermore, an accumulator 170 is mounted on the refrigerant circulation line R of the inlet side of the compressor 100.

The accumulator 170 is formed to divide the refrigerant supplied to the compressor 100 into liquid-phase refrigerant and gas-phase refrigerant and supply only the gas-phase refrigerant to the compressor 100.

Additionally, an electric heater 115 is further mounted inside the air-conditioning case 150 to abut on the downstream side of the indoor heat exchanger 110 in order to enhance heating performance.

That is, the electric heater 115 is operated as an auxiliary heat source at the initial starting of the vehicle in order to enhance heating performance, and may be operated when a heat source for heating is in short.

Preferably, the electric heater 115 is a PTC heater.

Meanwhile, like the expansion valve 185, the second expansion means 140 includes a solenoid valve, which is capable of opening and closing the expansion channel, and a bypass channel. In this instance, the dehumidification line R3 is connected with the evaporator 160 through the bypass channel of the second expansion means 140.

Hereinafter, actions of the heat pump system for the vehicle according to the preferred embodiment of the present invention will be described.

A. When the Battery is Cooled Using the Chiller in the Cooling Mode (FIG. 3)

The refrigerant in the cooling mode circulates through the compressor 100, the indoor heat exchanger 110, the first expansion means 120 (non-expansion), the outdoor heat exchanger 130, the second expansion means 140 (expansion), the evaporator 160, and the compressor 100 in order so as to cool the interior of the vehicle.

In this instance, when the battery 207 is cooled using the chiller 180, the expansion channel 186 of the expansion valve 185 mounted on the first bypass line R1 is opened by the solenoid valve 189, and the first refrigerant direction-changing valve 191 closes the auxiliary bypass line R4.

So, some of the refrigerant passing through the outdoor heat exchanger 130 flows to the first bypass line R1 and is expanded at the expansion valve 185, and then, circulates to the compressor 100 through the chiller 180.

As shown in FIG. 3, in connection with the flow of cooling water, the connection line 210 is closed by the cooling water adjusting means 200 so that the first cooling water line W1 and the second cooling water line W2 are configured independently.

Therefore, in the first cooling water line W1, the cooling water circulates through the first water pump 201, the electric component 202, the electric radiator 131 of the outdoor heat exchanger 130, the reservoir tank 203, and the first water pump 201 in order, so that the cooling water cooled by heat exchange with refrigerant and air in the electric radiator 131 cools the electric component 202.

In the second cooling water line W2, the cooling water circulates through the second water pump 205, the heating means 206 (unoperated), the battery 207, the chiller 180, and the second water pump 205 in order, so that the cooling water cooled by heat exchange with the refrigerant in the chiller 180 cools the battery 207.

As described above, cooling of the battery 207 using the chiller 180 is used when temperature of the cooling water cooled in the electric radiator 131 does not satisfy temperature requirements for cooling the battery 207 under the condition that temperature of outdoor air is high.

B. When the Battery is Cooled Using the Electric Radiator in the Cooling Mode (FIG. 4)

The refrigerant in the cooling mode circulates through the compressor 100, the indoor heat exchanger 110, the first expansion means 120 (non-expansion), the outdoor heat exchanger 130, the second expansion means 140 (expansion), the evaporator 160, and the compressor 100 in order so as to cool the interior of the vehicle.

In this instance, when the battery 207 is cooled using the electric radiator 131, the expansion channel 186 of the expansion valve 185 mounted on the first bypass line R1 is closed by the solenoid valve 189, and the first refrigerant direction-changing valve 191 closes the auxiliary bypass line R4.

As shown in FIG. 4, in connection with the flow of the cooling water, the connection line 210 is opened by the cooling water adjusting means 200 and a section of the second cooling water line W2 to which the chiller 180 is connected is closed, so that the battery 207 is connected to the first cooling water line W1 in parallel.

Therefore, in the first cooling water line W1, the cooling water circulates through the first water pump 201, the electric component 202, the electric radiator 131 of the outdoor heat exchanger 130, the reservoir tank 203, and the first water pump 201 in order, so that the cooling water cooled by heat exchange with refrigerant and air in the electric radiator 131 cools the electric component 202.

In this instance, some of the cooling water passing through the reservoir tank 203 of the first cooling water line W1 circulates through the second water pump 205, the heating means 206 (unoperated) and the battery 207 in order through the connection line 210 and the second cooling water line W2 so as to cool the battery 207 using the cooling water cooled in the electric radiator 131.

As described above, cooling of the battery 207 using the electric radiator 131 is used when temperature of the cooling water cooled in the electric radiator 131 satisfies temperature requirements for cooling the battery 207 under the condition that temperature of outdoor air is not high.

C. When Waste Heat of the Electric Component 202 and the Battery 207 are Recovered in the Heating Mode (FIG. 5)

The refrigerant in the heating mode circulates through the compressor 100, the indoor heat exchanger 110, the first expansion means 120 (expansion), the outdoor heat exchanger 130, the first bypass line R1, the chiller 180, and the compressor 100 in order so as to heat the interior of the vehicle.

In this instance, the expansion channel 186 of the expansion valve 185 mounted on the first bypass line R1 is closed by the solenoid valve 189, and the first refrigerant direction-changing valve 191 opens the auxiliary bypass line R4.

As shown in FIG. 5, in connection with the flow of the cooling water, the connection line 210 is opened by the cooling water adjusting means 200, and a section of the first cooling water line W1 to which the electric radiator 131 and the reservoir tank 203 are connected is closed, so that the electric component 202 is connected to the second cooling water line W2 in parallel.

Therefore, in the second cooling water line W2, the cooling water circulates through the second water pump 205, the heating means 206 (unoperated), the battery 207, the chiller 180, and the second water pump 205 in order, so that the cooling water heated in the battery 207 exchanges heat with the refrigerant in the chiller 180 to recover waste heat of the battery 207.

In this instance, the cooling water passing through the first water pump 201 and the electric component 202 of the first cooling water line W1 circulates to the chiller 180, so that the cooling water heated in the electric component 202 exchanges heat with the refrigerant in the chiller 180 to recover waste heat of the electric component 202.

That is, the cooling water passing through the second water pump 205 and the battery 207 of the second cooling water line W2 and the cooling water passing through the first water pump 201 and the electric component 202 of the first cooling water line W1 meet together while flowing in the opposite directions from each other, and then, pass through the chiller 180 so as to recover the waste heat of the electric component 202 and the waste heat of the battery 207.

As described above, recovery of the waste heat of the electric component 202 and the waste heat of the battery 207 is used when all of the electric component 202 and the battery 207 generate heat sufficiently.

D. When Waste Heat of the Electric Component 202 is Recovered in the Heating Mode (FIG. 6)

The refrigerant in the heating mode circulates through the compressor 100, the indoor heat exchanger 110, the first expansion means 120 (expansion), the outdoor heat exchanger 130, the first bypass line R1, the chiller 180, and the compressor 100 in order so as to heat the interior of the vehicle.

In this instance, the expansion channel 186 of the expansion valve 185 mounted on the first bypass line R1 is closed by the solenoid valve 189, and the first refrigerant direction-changing valve 191 opens the auxiliary bypass line R4.

As shown in FIG. 6, in connection with the flow of the cooling water, the connection line 210 is opened by the cooling water adjusting means 200, and a section of the second cooling water line W2 to which the second water pump 205, the heating means 206 and the battery 207 are connected is closed, so that the first water pump 201, the electric component 206 and the chiller 180 are connected in series.

Therefore, while the cooling water circulates the first water pump 201, the electric component 202, the chiller 180 and the first water pump 201 in order, the cooling water heated in the electric component 202 exchanges heat with the refrigerant in the chiller 180 to recover only waste heat of the electric component 202.

As described above, recovery of the waste heat of the electric component 202 is used when only waste heat of the electric component 202 is used because the electric component 202 generates heat but the battery 207 does not generate heat sufficiently.

E. When Waste Heat of the Battery 207 is Recovered in the Heating Mode (FIG. 7)

The refrigerant in the heating mode circulates through the compressor 100, the indoor heat exchanger 110, the first expansion means 120 (expansion), the outdoor heat exchanger 130, the first bypass line R1, the chiller 180, and the compressor 100 in order so as to heat the interior of the vehicle.

In this instance, the expansion channel 186 of the expansion valve 185 mounted on the first bypass line R1 is closed by the solenoid valve 189, and the first refrigerant direction-changing valve 191 opens the auxiliary bypass line R4.

As shown in FIG. 7, in connection with the flow of the cooling water, the connection line 210 is closed by the cooling water adjusting means 200 and the first cooling water line W1 is also closed because the first water pump 201 is stopped, so that the cooling water circulates only to the second cooling water line W2.

Therefore, the cooling water circulates through the second water pump 205, the heating means 206 (unoperated), the battery 207, the chiller 180, and the second water pump 205 in order, so that the cooling water heated in the battery 207 exchanges heat with the refrigerant in the chiller 180 to recover waste heat of the battery 207.

As described above, recovery of the waste heat of the battery 207 is used when only waste heat of the battery 207 is used because the battery 207 generates heat but the electric component 202 does not generate heat sufficiently.

In addition, the heating means 206 is operated under the condition that temperature-rising of the battery 207 is required to raise temperature of the battery 207 and supply heat to the heat pump system.

1. A heat pump system for a vehicle in which a compressor, an outdoor heat exchanger, an expansion means, and an evaporator are connected to a refrigerant circulation line, the heat pump system comprising:
a chiller connected to the refrigerant circulation line through a first bypass line in parallel;
a first cooling water line which connects the outdoor heat exchanger and an electric component for the vehicle to circulate cooling water;
a second cooling water line which connects the chiller and a battery for the vehicle to circulate cooling water; and
a cooling water adjusting means which connects the first cooling water line and the second cooling water line with each other to adjust a flow of cooling water between the first and second cooling water lines,
wherein through the chiller, waste heat of the electric component or the battery is recovered in a heating mode, and the battery is cooled to make heat management of the battery possible in a cooling mode.

2. The heat pump system according to claim 1, wherein the cooling water adjusting means comprises:
a connection line which connects the first cooling water line and the second cooling water line in parallel to arrange the outdoor heat exchanger, the electric component, the chiller and the battery in parallel; and
a valve mounted at a branching point between the first and second cooling water lines and the connection line to adjust a flow of the cooling water.

3. The heat pump system according to claim 2, wherein the connection line connects the first cooling water line of inlet and outlet sides of the electric component and the second cooling water line of inlet and outlet sides of the chiller in parallel.

4. The heat pump system according to claim 3, wherein the valve comprises:
first and second cooling water direction-changing valves respectively mounted at branching points between the first cooling water line of the inlet side of the electric components and the connection line and between the first cooling water line of the outlet side of the electric components and the connection line; and
a third cooling water direction-changing valve mounted at a branching point between the second cooling water line of the inlet side of the chiller and the connection line.

5. The heat pump system according to claim 1, wherein the outdoor heat exchanger comprises:
an electric radiator which exchanges heat between refrigerant of the refrigerant circulation line and cooling water of the first cooling water line; and
an air-cooled heat exchanger which exchanges heat between the refrigerant of the refrigerant circulation line and the air.

6. The heat pump system according to claim 5, wherein the electric radiator and the air-cooled heat exchanger are arranged in a straight line in a flow direction of air blown from a blast fan.

7. The heat pump system according to claim 1, wherein a first water pump for circulating the cooling water and a reservoir tank for storing the cooling water are mounted on the first cooling water line, and
wherein a second water pump for circulating the cooling water is mounted on the second cooling water line.

8. The heat pump system according to claim 1, wherein a heating means for heating the cooling water circulating to the battery is mounted on the second cooling water line.

9. The heat pump system according to claim 1, wherein an expansion channel for expanding the refrigerant and an expansion valve having a bypass channel bypassing the expansion channel are mounted on the first bypass line of the inlet side of the chiller so as to selectively expand the refrigerant flowing to the chiller.

10. The heat pump system according to claim 9, wherein the expansion valve further comprises a solenoid valve for opening and closing the expansion channel.

11. The heat pump system according to claim 9, wherein the expansion valve is combined to one side of the chiller.

12. The heat pump system according to claim 9, wherein the first bypass line branches off from the refrigerant circulation line of the outlet side of the outdoor heat exchanger and meets the refrigerant circulation line of the outlet side of the evaporator, so that the refrigerant passing the outdoor heat exchanger bypasses the evaporator,
wherein an auxiliary bypass line is mounted to connect the bypass channel of the expansion valve with the refrigerant circulation line before the first bypass line branches off, and
wherein a first refrigeration direction-changing valve is mounted at a branching point between the refrigerant circulation line and the auxiliary bypass line.

13. The heat pump system according to claim 12, wherein when the battery is cooled in the cooling mode, the cooling water adjusting means is controlled such that the cooling water cooled in the outdoor heat exchanger circulates toward the electric component of the first cooling water line and the cooling water cooled in the chiller circulates toward the battery of the second cooling water line, the expansion valve is controlled to expand the refrigerant and the first refrigerant direction-changing valve is controlled to close the auxiliary bypass line so as to cool the battery using the chiller.

14. The heat pump system according to claim 12, wherein when the battery is cooled in the cooling mode, the cooling water adjusting means is controlled such that the cooling water cooled in the outdoor heat exchanger circulates the electric component of the first cooling water line and the battery of the second cooling water line, the expansion valve is controlled to closed the expansion channel, and the first refrigerant direction-changing valve is controlled to close the auxiliary bypass line so as to cool the battery using the outdoor heat exchanger.

15. The heat pump system according to claim 12, wherein when waste heat is recovered in the heating mode, the cooling water adjusting means is controlled such that the cooling water heated in the electric component and the cooling water heated in the battery circulate toward the chiller of the second cooling water line, the expansion valve is controlled to close the expansion channel, and the first refrigerant direction-changing valve is controlled to open the auxiliary bypass line so as to recover waste heat using the electric component and the battery.

16. The heat pump system according to claim 12, wherein when waste heat is recovered in the heating mode, the cooling water adjusting means is controlled such that only the cooling water heated in the electric component circulates toward the chiller of the second cooling water line, the expansion valve is controlled to close the expansion channel, and the first refrigerant direction-changing valve is controlled to open the auxiliary bypass line so as to recover waste heat using the electric component.

17. The heat pump system according to claim 12, wherein when waste heat is recovered in the heating mode, the cooling water adjusting means is controlled such that only the cooling water heated in the battery circulates toward the chiller of the second cooling water line, the expansion valve is controlled to close the expansion channel, and the first refrigerant direction-changing valve is controlled to open the auxiliary bypass line so as to recover waste heat using the battery.

18. The heat pump system according to claim 1, wherein an indoor heat exchanger is disposed between the compressor and the outdoor heat exchanger.

19. The heat pump system according to claim 1, wherein when the battery is cooled in the cooling mode, the cooling water adjusting means is controlled such that the cooling water cooled in the outdoor heat exchanger circulates toward the electric component of the first cooling water line and the cooling water cooled in the chiller circulates toward the battery of the second cooling water line.

20. The heat pump system according to claim 1, wherein when the battery is cooled in the cooling mode, the cooling water adjusting means is controlled such that the cooling water cooled in the outdoor heat exchanger circulates the electric component of the first cooling water line and the battery of the second cooling water line.

21. The heat pump system according to claim 1, wherein when waste heat is recovered in the heating mode, the cooling water adjusting means is controlled such that the cooling water heated in the electric component and the cooling water heated in the battery circulate toward the chiller of the second cooling water line.

22. The heat pump system according to claim 1, wherein when waste heat is recovered in the heating mode, the cooling water adjusting means is controlled such that only the cooling water heated in the electric component circulates toward the chiller of the second cooling water line.

23. The heat pump system according to claim 1, wherein when waste heat is recovered in the heating mode, the cooling water adjusting means is controlled such that only the cooling water heated in the battery circulates toward the chiller of the second cooling water line.
